(19) United States
(12) Patent Application Publication
(10) Pub. No.: US 2017/0123873 A1
(43) Pub. Date: May 4, 2017

(54) COMPUTING HARDWARE HEALTH CHECK

(71) Applicant: Saudi Arabian Oil Company, Dhahran (SA)

(72) Inventors: Majdi A. Baddourah, Dhahran (SA); Ali A. Al-Turki, Dhahran (SA)

(21) Appl. No.: 14/927,261

(22) Filed: Oct. 29, 2015

(51) Int. Cl. G06F 11/07; G06F 9/50

(52) U.S. Cl. CPC G06F 11/079; G06F 9/5005; G06F 11/0709; G06F 11/0751; G06F 11/0793

(57) ABSTRACT

Example computer-implemented methods, computer-readable media, and computer systems are described for performing a computing node health check. In some aspects, a routine health check of a plurality of computing nodes of a computer system is performed. A computing job is assessed. A first set of computing nodes are allocated from the plurality of computing nodes to the computing job. A prior-job-execution diagnosis is performed on the first set of computing nodes. Whether the first set of computing nodes are all healthy is determined. In response to determining that the first set of computing nodes are healthy, the job is executed. The job is monitored while the job is running Whether the job fails or succeeds is determined. In response to determining that the job fails, a post-job-execution diagnosis is performed on an exit code of the job. A result of the post-job-execution diagnosis is output via a user interface of the computer system.

### TECHNICAL FIELD

This disclosure relates to checking health of computing nodes in a computer system.

### BACKGROUND

A computer system can include multiple computing nodes. In some instances, when a user submits a job to a job scheduler, the job scheduler can allocate computing nodes to this job. Some of these computing nodes may be defective. This will cause the job to fail, requiring re-submission of the job. If there is at least one faulty computing node, other jobs utilizing the faulty computing node will also fail, which in turn creates a domino-like effect. Techniques to address the problems are desirable.

### SUMMARY

This disclosure relates to checking health of computing nodes in a computer system.

In general, example innovative aspects of the subject matter described here can be implemented as a computer-implemented method, implemented in a computer-readable media, or implemented in a computer system, for checking health of computing nodes in a computer system. One computer-implemented method includes performing, by operation of a computer system, a routine health check of a plurality of computing nodes of a computer system; accessing, by operation of the computer system, a computing job; allocating a first set of computing nodes from the plurality of computing nodes to the computing job; performing a prior-job-execution diagnosis on the first set of computing nodes; determining whether the first set of computing nodes are all healthy; in response to determining that the first set of computing nodes are healthy, executing the job; monitoring the job while the job is running; determining whether the job fails or succeeds; in response to determining that the job fails, performing a post-job-execution diagnosis on an exit code of the job; and outputting, via a user interface, a result of the post-job-execution diagnosis.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes (or causes the system) to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, further comprising determining whether the first set of computing nodes are not all healthy; in response to determining that the first set of computing nodes are not all healthy, identifying one or more bad computing nodes from the first set of computing nodes; and prior to executing the job, allocating a second set of computing nodes from a healthy computing node pool to the job.

A second aspect, combinable with any of the previous aspects, further comprising isolating the one or more bad computing nodes from healthy computing nodes of the first set of computing nodes; fixing the one or more bad computing nodes; testing the one or more fixed bad computing nodes; and in response to determining that the one or more fixed bad computing nodes pass an extensive health check, putting the one or more fixed bad computing nodes to the healthy node pool.

A third aspect, combinable with any of the previous aspects, further comprising in response to determining that the first set of computing nodes are not all healthy, sending the job back to a scheduler; and marking the job with a higher priority to be scheduled for execution.

A fourth aspect, combinable with any of the previous aspects, where performing the prior-job-execution diagnosis comprises one or more of performing syntax check, resources optimization, resource allocation, or an extensive health check.

A fifth aspect, combinable with any of the previous aspects, where performing the post-job-execution diagnosis comprises: categorizing an error of the job; fixing the error of the job according to a category of the error; and resubmitting the job.

A sixth aspect, combinable with any of the previous aspects, where categorizing the error of the job comprises categorizing the error into one or more of a syntax error, an application error, an environment error, a hardware error or another error.

A seventh aspect, combinable with any of the previous aspects, where monitoring the job while the job is running comprises performing a health check with a frequency not to impact the running job; and checking, in parallel with performing the health check, progress of the job to determine that the job is alive and still running.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description in the following. Other features and advantages of the disclosure will be apparent from the description and drawings, and from the claims.

### BRIEF DESCRIPTION OF THE DRAWINGS

FIG. 1 is a block diagram illustrating an example computer system for performing a computing hardware health check, according to an implementation.

FIGS. 2A and 2B is a flowchart illustrating an example overall process for a computing hardware health check, according to an implementation.

FIG. 3 is a flowchart illustrating an example Syntax Check, Computing Resources Optimization, Allocation, and Extensive Health Check workflow, according to an implementation.

FIG. 4 is a flowchart illustrating an example process of Computing Resources Optimization, Allocation, and Extensive Health Check, according to an implementation.

FIG. 5 is a block diagram illustrating an example job monitoring process, according to an implementation.

FIG. 6 is a block diagram illustrating an example environment error checking process, according to an implementation.

FIG. 7 is a flowchart illustrating an example process for performing a computing node health check, according to an implementation.

Like reference numbers and designations in the various drawings indicate like elements.

### DETAILED DESCRIPTION

This disclosure describes computer-implemented methods, software, and systems for checking health of computing nodes in a computer system. A computing node can include one or more of a processor with one or more cores, an I/O interface, an InfiniBand card, fans, memory, or any other components of a data-processing apparatus and resources. A computing node can be regarded as healthy if all its components are functioning as designed and tested.

The example techniques can be used, for example, in a Linux High Performance Computing (HPC) environment, a faulty environment, or other types of computer systems. In some instances, the example techniques can be referred to as high performance computing (HPC) hardware health checks. In some implementations, the example techniques can be implemented as a combination of algorithms, programs, scripts and workflows that all work together too extensively and thoroughly check compute-resources and ensure they are healthy before allocating them for a simulation job, during job execution, or after the simulation job finishes. The example techniques provide a mechanism by which the detection and reporting of bad-resources is performed automatically. For example, automated mechanisms are provided for checking error/exit codes, fixing and reporting issues, and resubmission computing nodes for use. In some implementations, several diagnostics programs can be run on top of the regular diagnostics performed prior to marking the computing nodes as unavailable resources from the scheduler perspective.

In some implementations, user and simulation environment errors are checked prior to job submission and during job execution. Consequently, the unhealthy (bad) resources (for example, bad computing nodes) can be automatically isolated and reported to support personnel for in-depth analysis and resolution. In some implementations, environment errors/problems are checked, fixed and resolved on the fly. The bad resources can be cleared by support personnel (for example, an administrator or a user).

On the other hand, if the simulation job finished abnormally, the diagnostics scripts can analyze the exit codes for various hardware failures to isolate the resources and report the failure for further actions. If there are not any hardware failures, the resources are released and put back in resource pools. The attention can be directed to the other possible causes of job termination, like user input errors, software bugs, or reservoir simulation environment problems. In some implementations, jobs that are failed due to user errors can be classified into simple and complex ones. The simple ones can be fixed and the job is resubmitted on behalf the user, whereas for the complex ones a list of suggested fixes can be generated and shared with the user and the support personnel. The simulator errors are reported, for example, to the simulator developer group for remedial actions.

The example techniques can achieve a number of advantages. For example, the example techniques take automated analysis procedures for discovery, reporting, and corrective and preemptive actions for checking health of computing nodes allocated for a simulation job. The example techniques can reduce the number of simulation jobs failures due to hardware, environment, user input, or other types of issues. The example techniques can offer a reduced probability of jobs failures of up to 60% in some instances. The example techniques can save compute cycles, resources, and reservoir simulation engineers' time, and thus expedite project delivery. For instance, the example techniques can reduce the turnaround time to complete a reservoir simulation study and enhance on resources optimization. In addition, the example techniques can help support personnel to better detect, isolate, and resolve the issue. In some implementations, the detection is performed automatically by an extensive resources check prior, during, and post to resource allocation computation, job running, and job completion, respectively. The example techniques can expedite the problem identification and mitigation actions, which leads to more stable high-performance computing environment. The example techniques can reduce and prevent possible delays that might be caused by computing resources unavailability, and thus provide higher availability and reliability of a computer system that can provide, for example, demanding computing requirements for scientific and engineering projects. The example techniques can achieve additional or different advantages.

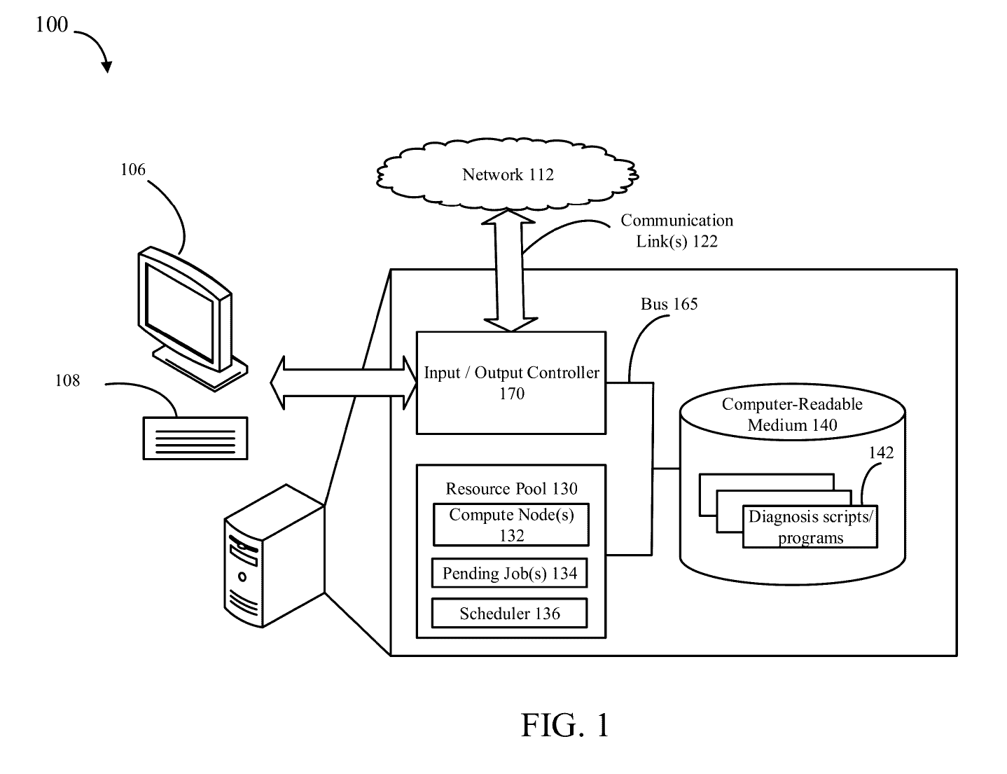

FIG. 1 is a block diagram illustrating an example computer system 100 for performing a computing hardware health check, according to an implementation. The example computer system 100 includes a resource pool 130, a computer-readable medium 140 (for example, a memory), and input/output controllers 170 communicably coupled by a bus 165. The computer system 100 or any of its components can be located apart from the other components shown in FIG. 1. For example, the computer system 100 can be located at a data processing center, a computing facility, a laboratory, a company, or another suitable location. The computer system 100 can include additional or different features, and the features of the computer system can be arranged as shown in FIG. 1 or in another configuration. The example computer system 100 can represent a Linux High Performance Computing (HPC) environment (for example, a HPC cluster running Linux or other computer operating system), a faulty environment, or other types of computer systems.

The resource pool 130 can include one or more computing nodes 132, one or more pending jobs 134, and a scheduler 136. The computing nodes 132 can include, for example, one or more cores, processors or other data processing apparatus. The one or more computing nodes 132 can have the same or different processing power. One or more computing node 132 can be assigned to a computing job by the scheduler 136, for example, according to priority, user request, or other criteria or scheduling algorithms. The one or more jobs 134 can include, for example, simulation jobs submitted by the user or required by the computer system 100. The jobs can run on the one or more computing nodes that are allocated by the scheduler 136. The scheduler can be a HPC scheduler running on Linux servers or other types of schedulers. In some implementations, the scheduler can be implemented by a dedicated processor or one or more of the computing nodes 132 can be configured to perform functionality of the scheduler 136.

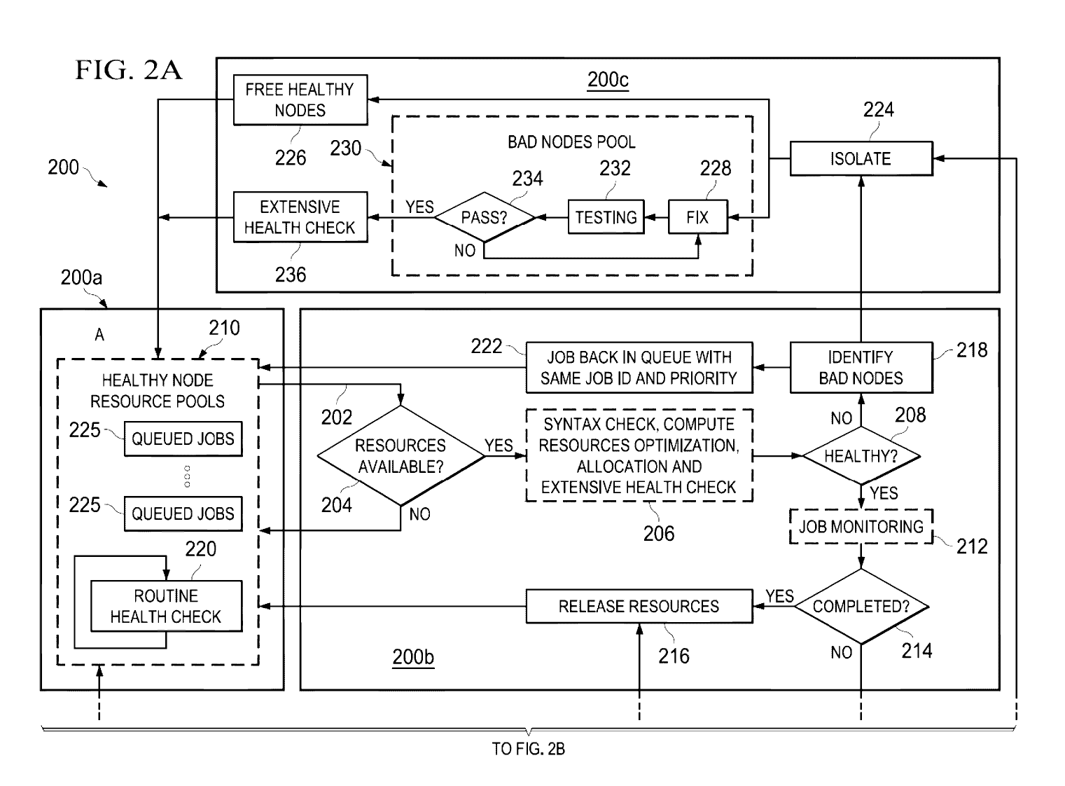

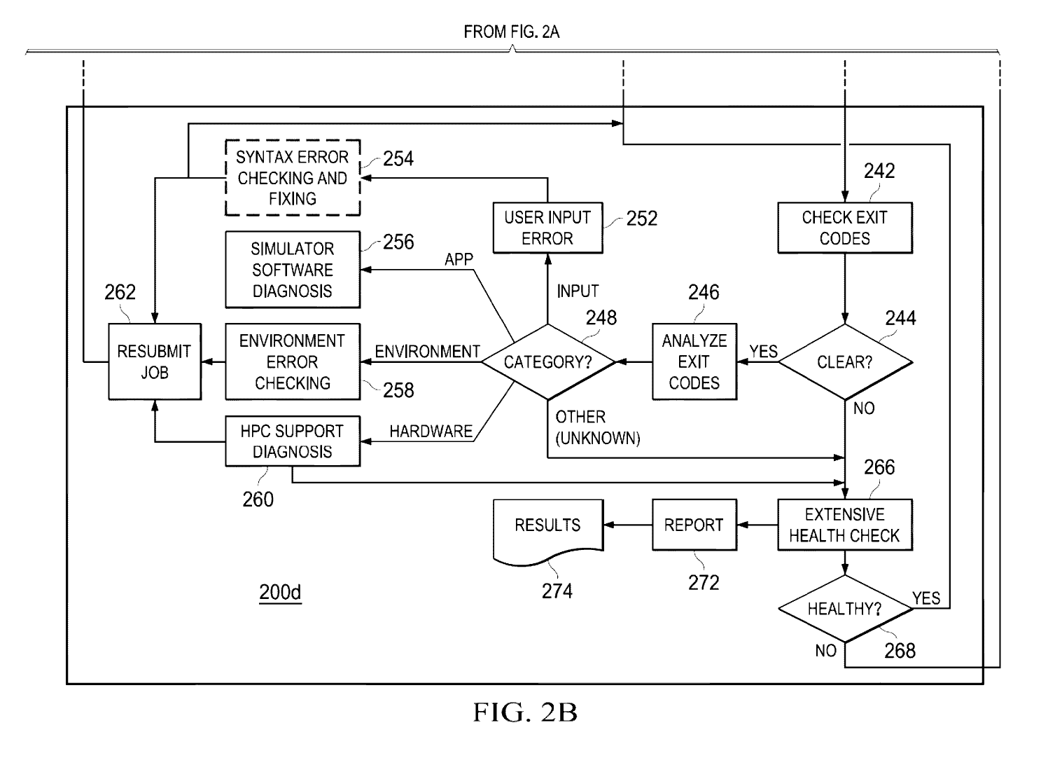

The computer-readable medium 140 can include scripts, programs, or other modules 142 that can perform workflows and check operations described with respect to FIGS. 2A-7. For example, the computer-readable medium 140 can include one or more check or diagnosis programs/scripts 142 that use Linux commands or other programs to perform a computing node health check. The computer-readable medium 140 can store simulation results.

The computer-readable medium 140 can include, for example, a random access memory (RAM), a storage device (for example, a writable read-only memory (ROM) and/or others), NAS (Network Attached Storage), a hard disk, and/or another type of storage medium. The computer-readable medium 140 can include high-performance storage with high availability, for example, based on Direct Data Networks Technology (DDN). The computer system 100 can be preprogrammed and/or it can be programmed (and reprogrammed) by loading a program from another source (for example, from a CD-ROM, from another computer device through a data network, and/or in another manner).

The input/output controller 170 is coupled to input/output devices (for example, the display device 106, input devices 108 (for example, keyboard, mouse, etc.), and/or other input/output devices) and to a network 112. The input/output devices can, for example, via a user interface, receive user input (for example, simulation jobs or user commands) and output the computing results (for example, in graph, table, text, or other formats). For example, simulation results can be saved to and retrieved from NAS. Desktop workstations can be example front-end input/output devices for simulation jobs submission, data analysis, and visualization.

The input/output devices receive and transmit data in analog or digital form over communication link(s) 122 such as a serial link, wireless link (for example, infrared, radio frequency, and/or others), parallel link, and/or another type of link.

The network 112 can include any type of data communication network. For example, the network 112 can include a wireless and/or a wired network, a Local Area Network (LAN), a Wide Area Network (WAN), a cellular network, a private network, a public network (such as the Internet), a WiFi network, a network that includes a satellite link, and/or another type of data communication network.

FIGS. 2A and 2B represent a flowchart illustrating an example overall process 200 for a computing hardware health check, according to an implementation. The example process 200 can be a multi-level and multi-stage health checks of computing resources (for example, computing nodes). The example process 200 can couple multiple procedures and routines. As illustrated, the example process 200 includes workflow A 200a, workflow B 200b, workflow C 200c, and workflow D 200d. Some operations of the example process 200 can be performed before resources allocation, before a computing job starts, when the job is running, after the job finishes, or at another time.

The process 200 can be implemented, for example, as computing instructions stored on computer-readable media and executable by data-processing apparatus (for example, the computer system 100 in FIG. 1). In some implementations, some or all of the operations of process 200 can be distributed to be executed by a cluster of computing nodes, in sequence or in parallel, to improve efficiency. The example process 200, individual operations of the process 200, or groups of operations may be iterated or performed simultaneously (for example, using multiple threads). In some cases, the example process 200 may include the same, additional, fewer, or different operations performed in the same or a different order.

Workflow A 200a can be performed to maintain and manage a resource pool (for example, the resource pool 130 in FIG. 1). The resource pool can include or be divided into a healthy computing node pool 210 and a bad computing node pool 230. The workflow A 200a can be performed by a job scheduler (for example, the scheduler 136 in FIG. 1), for example, to execute a routine heath check 220 of computing nodes of the computer system (for example, the processors 132 of the computer system 100 in FIG. 1) and maintain and manage one or more queued jobs 225. The workflow A 200a can be implemented, for example, as add-ons that include lightweight programs to ensure that the available/free resources are through running automated routine health check programs. In the example of an HPC environment, the workflow A 200a can be implemented on top of the routine HPC scheduler functions to manage an HPC resource pool.

In some implementations, the routine health check programs 220 are run periodically. When a job submitted by a user is ready to be performed at 202, the job scheduler can allocate one or more computing nodes to this job from a number of computing nodes of the computer system. The one or more computing nodes can come from the healthy computing node pool 210, the bad computing node pool, or both. After the computing node allocation, workflow B 200b can be triggered.

Example functionalities of workflow B 200b include allocating computing resources, optimizing computing resources, and running extensive resource health checks, identifying and marking any bad resource, putting back a job in scheduler queue with priority to run before other jobs, and monitoring the job while running. The workflow B 200b can be performed, for example, by the scheduler or other data-processing apparatus of a computer system. In some implementations, lightweight health check routines are run, at a relatively less frequency, against the participating computing nodes in the running simulation job. It also monitors the job progress to ensure that the job is running and is not hung.

In some implementations, before the job starts, a batch of scripts/applications is run on the participating computing nodes that were allocated to the job. “Matrix Multiply” operations can be running on a single core for monitoring the runtime. MPI Communication code contains (allreduce or send and receive) runs on all computing nodes which allow monitoring of the communication time (latency) and the communication health between computing nodes. Scripts that contain Linux commands such as “df/ls/” can be used to make sure the file systems involved in the simulation run are available and responsive. The file systems involved should have the data, the output of the run, and the executables. In some implementations, ssh secure connection protocol commands can be used on all computing nodes listing home directory on Linux to check if the user has an account on computing nodes. In some implementations, whether the environment for the user is correct on all computing nodes can be checked, for example, using a Linux command similar to:

df -h|grep peddn2.

In this manner, many file systems can be checked. Any modified environment or a missing environment on any computing node can be flagged and removed from the scheduler. Additional or different commands, operations, scripts, and programs can be used to perform the functionalities of the workflow B 200b and other workflows.

At 204, whether there are available computing resources is determined. If there are no available computing resources, the workflow B 200b goes back to workflow A 200a to wait for available and allocated computing resources. In some instances, the example operation 204 can be implemented as a continuous wait-check cycle that will end only when the resources become available and allocated. If there are available computing resources of the computing job, the workflow B 200b proceeds to 206. “Syntax Check, Computing Resources Optimization, Allocation, and Extensive Health Check” workflow 206 is triggered. The Syntax Check, Computing Resources Optimization, Allocation, and Extensive Health Check workflow 206 can include one or more sub-workflows.

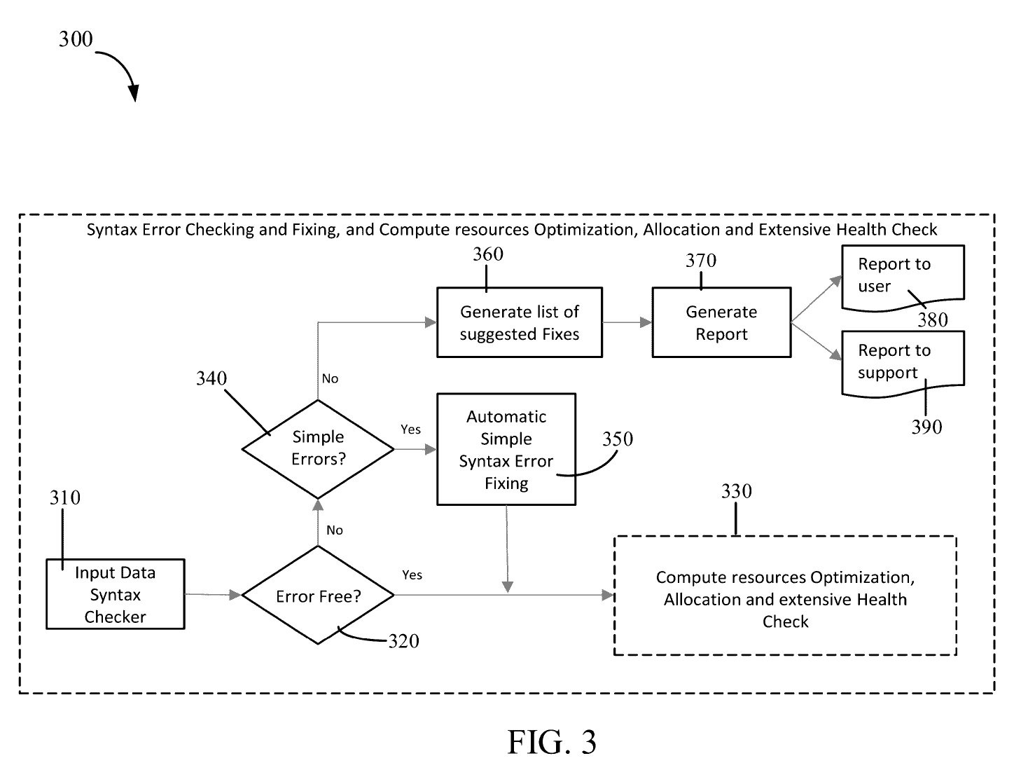

FIG. 3 is a flowchart illustrating an example process 300 of Syntax Check, Computing Resources Optimization, Allocation, and Extensive Health Check workflow 206, according to an implementation. In some implementations, the workflow 206 can include additional or different operations and may be performed in a different manner as illustrated in FIG. 3.

At 310, the input data is checked for syntax errors, for example, by an input data syntax checker. If no error is found at 320, the example process 300 can proceed to perform computing resources optimization, allocation, and extensive health check 330.

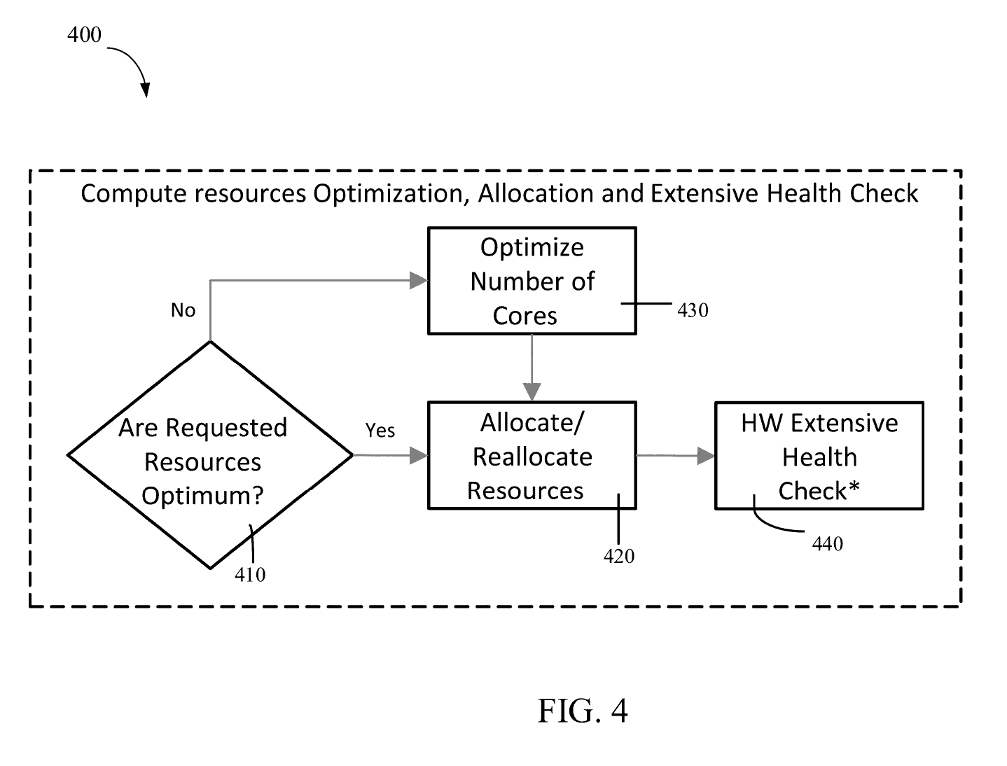

FIG. 4 is a flowchart illustrating an example process 400 of Computing Resources Optimization, Allocation, and Extensive Health Check (for example, the computing resources optimization, allocation and extensive health check 330 in FIG. 3), according to an implementation. At 410, the requested resources are checked to determine whether they are optimal or appropriate, for example, in terms of number of computing nodes versus the simulation model complexity. A user can request a number of computing cores for the job, which may not be optimal or appropriate for the job or given the available resources of the computer system. In some implementations, an appropriate number of computing nodes for the job can be calculated before computing node allocation, for example, based on the model size (for example, number of cells), type (black-oil, compositional, etc.), complexity, etc. In some implementations, a formula can be used to calculate the optimal number of computing cores. For example, for black-oil models, it is determined that fifty thousand cells should be allocated to one computing core. For example, given a model with one hundred million cells, it is recommended to run on two thousand cores. If the requested resources are optimal (for example, equal to the optimal number of computing nodes for the job), at 420, the requested resources are allocated to the job. If the requested resources are not optimal, at 420, the number of computing nodes can be optimized or otherwise adjusted at 430. Then the adjusted number of computing nodes are allocated to the job at 420. From 420, the example process 400 proceeds to execute an extensive health check 440. The extensive health check 440 can include, for example, MPI I/O check (for example, for InfiniBand communication), computing node ping (health), extensive memory checks, and file system mounts (for example, according to the afore-mentioned checks associated with file systems using commands such as df/ls/, ssh, df -h|grep peddn2, etc.).

The MPI I/O check can be performed on the I/O system using MPI I/O. A small job can be run before the simulation job starts. The I/O performance is checked and compared against the manufacturer specifications. If the I/O numbers is less than specifications then the list of computing nodes will be rejected.

The computing node ping or computing node health check can include one or more levels of automatic checks. Level 1: ping command will return if the computing node is accessible (alive) or not from an operating system's view. Level 2: check the availability of the computing node from the scheduler's perspective. Level 3: if the computing node passes Levels 1 and 2 then computing node performance and memory checks are run. Level 4: upon passing Level 3, the interconnect (Infiniband) is checked for performance.

Extensive memory check can include, for example, checking limits of the computing nodes using limit commands and grep for stacksize which should be unlimited. As another example, a small test code can be execute to access all memory on a computing node. If the job fails then this computing node will be removed from the good computing nodes list.

Referring back to FIG. 3, if the syntax check failed at 320, then the error can be classified as simple or complex at 340. The simple error can be automatically fixed, for example, by an automatic simple syntax error fixing program 350. Then the example process 300 proceeds to perform computing resources optimization, allocation, and extensive health check 330.

If the error is not a simple syntax error, a list of suggested fixes can be generated at 360. Then a report can be generated at 370 and reported to the user at 380 and to the support personnel (for example, an administrator) at 390.

Referring back to FIG. 2A, after performing the Syntax Check, Computing Resources Optimization, Allocation, and Extensive Health Check 206, whether the allocated computing nodes are healthy is determined at 208, for example, by determining whether one or more of the preceding operations or checks successfully went through. The healthy computing nodes can be flagged or otherwise marked as a usable resource. If one of the jobs or operations fails to run using one or more allocated computing nodes, the one or more computing nodes can be identified as bad computing nodes at 218. The bad computing nodes can be identified manually by an administrator or automatically by the computer system, for example, according to the computing node health check. Once the bad computing nodes are identified, the bad computing nodes can be removed from performing the job from the scheduler. Workflow C 200c can be triggered. In some implementations, at 222, the job is sent back to the queue with the same job ID and an appropriate priority (for example, a higher priority), waiting for its turn to be performed. The scheduler can schedule a new set of computing nodes from the healthy computing node pool 210 to the job without the bad computing nodes. Workflow A 200a can be triggered and the process can be repeated.

Workflow C 200c can be triggered when bad HPC resources are identified (for example, from workflow B 200b or D 200d). In the workflow C 200c, at 224, the bad computing nodes are isolated from healthy computing nodes that were allocated to the job. The healthy computing nodes that were allocated to the job can be freed at 226 and put back into the healthy computing nodes pool 210. On the other hand, the bad computing nodes can be put into a bad computing node pool 230. The bad computing nodes can be reported to HPC support personnel. The bad computing nodes can be fixed at 228 and tested at 232 (for example, software support tests the fixes). Before finally approving the fixes and the computing node is marked as healthy and put into the available resources' pool, the computing node has to pass the extensive health check and benchmark simulation jobs. If they pass the test at 234, the computing nodes can execute an extensive health check 236. The extensive health check 236 can include the same or different operations as the extensive health check 440. After passing the extensive health check 236, the computing nodes can be put into the healthy computing node pool 210. If the computing nodes fail the test at 234, the computing nodes can be fixed again until it passes the test.

Referring back to 208, if all computing nodes allocated to the job are identified as healthy computing nodes, then the job will start running utilizing the set of healthy computing nodes. While the job is running, “Job monitoring” workflow 212 is triggered. The job monitoring programs can monitor the job progress, output frequency, and run lightweight health checks while the job is running. If the job was completed at 214, then the resources are released at 216 and workflow A 200a is triggered again. If the job was not successfully completed at 214, then workflow D 200d is triggered.

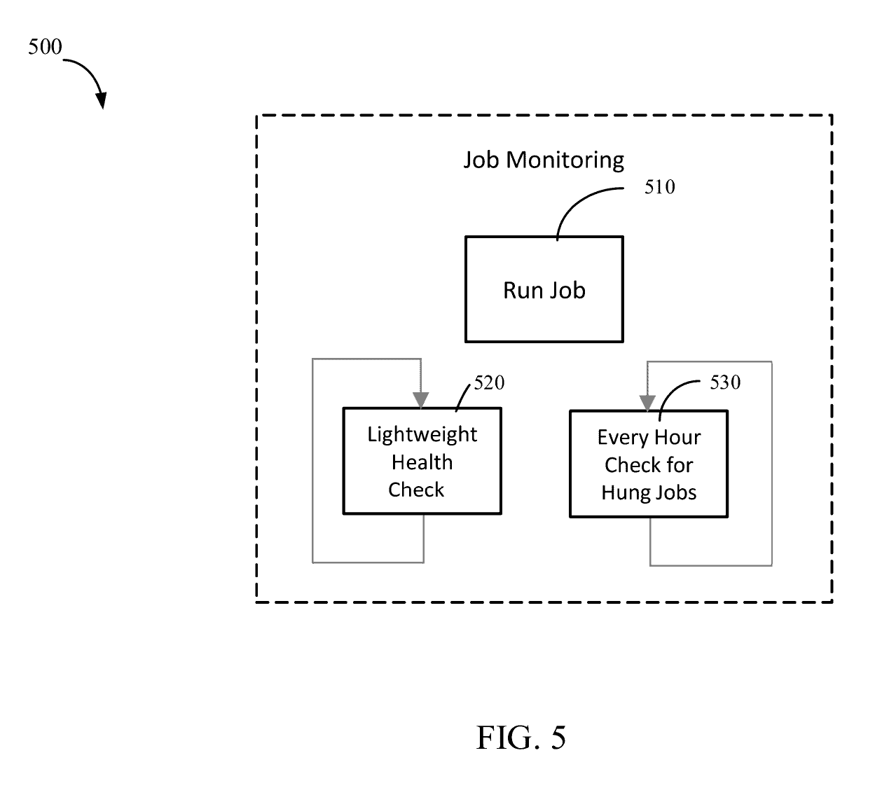

FIG. 5 is a block diagram illustrating an example job monitoring process 500, according to an implementation. While the job is running at 510, the lightweight health checks 520 are run with a less frequency (for example, every ten minutes) to not impact the running job. If any of the health checks failed then, workflow D 200d can be triggered. In parallel, at 530, the job's progress can be checked every hour to determine that the job is alive and still running Otherwise, workflow D 200d is triggered.

Workflow D 200d can be triggered once the simulation job is complete either successfully or otherwise. It scans the simulator, scheduler and system exit codes. If the job is successful then the scheduler cleans up the processes. The resources are then taken to Workflow A 200A where the routine health check is run. If the job has failed then the exit codes are automatically checked, analyzed, and categorized to either user input errors, simulator errors, HPC resource error, environment errors, or others (unknown or unclassified exit codes). In any case, the support personnel can be notified to take further actions. Reports are generated at the end of each process allowing further investigation. With this workflow, several workflows could be triggered depending on the exit code category. In any case, the problems/issues are resolved, users are notified, and the job can be resubmitted on behalf of the user.

In some implementations, Linux scripts can be triggered to run on the simulation output files to make sure that the job was successfully completed. If the job was unsuccessful then other Linux scripts will try to identify the errors and make corrections if necessary. An example of this could be a job completing with zero output. The size of the output file will be examined and checked. If it is zero, then the health of the computing nodes will be examined using scripts/applications to make sure to capture the bad computing node(s) that caused the job not to start in the first place. The proper actions will be taken (for example, workflow C 200c) and the job will be resubmitted. The workflow D 200d can be implemented by commands, operations, scripts, and programs similar to those described with respect to workflow B 200b. In some instances, the workflow D 200d can be implemented in another manner.

In the workflow D 200d, the exit codes can be checked and analyzed at 242. Whether the exit codes are clear can be determined at 244. Clear exit codes can include exit codes that indicate CPU limit exceeded. Example exit codes can include a high-count number of cores and simulator predefined exit codes. In the case of clear exit codes, error are automatically detected and rectified, and the job can be resubmitted on behalf of the user. On the other hand, unclear exit codes can include exist codes that indicate, for example, segmentation fault, kill signal, hung jobs, and zero simulation output. In this case, examining and resolving the issue can be performed manually which may involve the user, developer or support personnel.

If the exit codes are clear, the exit codes are analyzed at 246. The exit codes can be analyzed to identify different categories of errors. Example categories include user input errors, application errors, environment errors, and hardware errors, and other errors. Additional or different categories of errors can be used for analyzing the exit codes.

If the error can be identified as a user input error, then the “Syntax Error Checking and Automatic Fixing” workflow 254 can be initiated. The Syntax Error Checking and Automatic Fixing workflow 254 can include similar operations to the example Syntax Check, Computing Resources Optimization, Allocation, and Extensive Health Check workflow 300. For example, if it is a simple syntax error, then it can be automatically fixed. The Syntax Error Checking and Automatic Fixing workflow 254 can differ from the example Syntax Check, Computing Resources Optimization, Allocation, and Extensive Health Check workflow 300 by replacing the computing resources optimization, allocation, and extensive health check 330 with a next operation of the workflow 254 in workflow D 200d. In some implementations, the example Error Checking and Automatic Fixing workflow 300 can be used in other workflows, for example, for syntax check and fixing, by replacing the computing resources optimization, allocation, and extensive health check 330 with a next operation in the other flows.

If the error is related to the application (for example, the simulator software), the simulator Software Diagnosis workflow 256 can be triggered to identify and fix the application error. In some implementations, the applications can be identified by debugging, which includes reproducing the error, identifying the module and code revisions, and testing. In some implementations, application errors once identified can be sent to the developer automatically, for example, via e-mail, to be fixed.

If the error is related to simulation environment, the “Environment Error Checking” workflow 258 can be triggered.

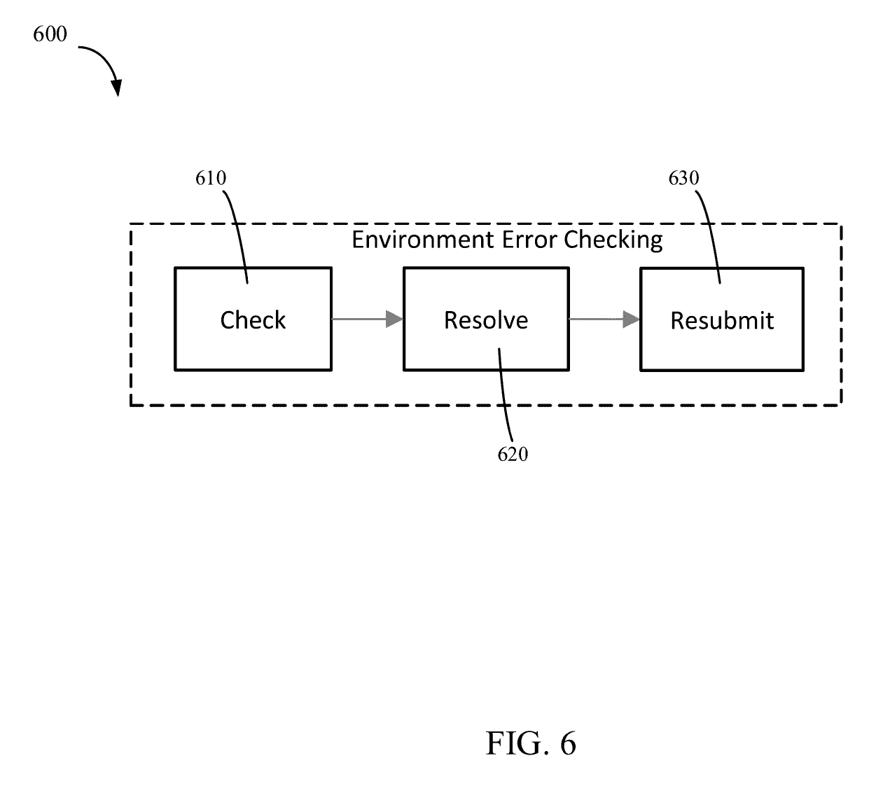

FIG. 6 is a block diagram illustrating an example environment error checking process 600, according to an implementation. The environment error checking sub-workflow 600 can be triggered whenever issues or problems caused by or related to the simulation environment like storage mounts and zero output simulation jobs. The simulation environment can be checked at 610, errors/problems can be handled at 620. For example, the environment errors can be handled by checking if the user has “.cshrc” (configuration file) file in the user's home directory. If not, then the script can make a copy of the master “.cshrc” file to the user directory. The job can be resubmitted at 630.

If the error is a hardware problem, the HPC Support Diagnosis workflow 260 can be triggered. The HPC Support Diagnosis workflow 260 can return resources back to production as soon as possible in states that can contribute in simulation jobs. For example, the HPC Support Diagnosis workflow 260 can include one or more operations such as receiving notification, checking hardware logs, identifying the problem and setting an action plan (ensure no effects on the environment), resolving the problem offline, testing, and returning to production. After the diagnosis at 260, the computing node can be put through an extensive health check at 266 and proceed from there.

In some implementations, all of the diagnosis tasks (for example, the workflows 254, 256, 258, and 260) can be automatically performed. The errors/problems can be reported to the respective support entity for handling. After a diagnosis workflow finishes, the job can be resubmitted on behalf of the user at 262. Workflow A 200a can be triggered again. In some implementations, once the error has been fixed, the resources can be released and put back to the healthy resource pool 210.

If the error is of an unknown type, a hardware (HW) extensive health check workflow 266 can be executed. The extensive health check workflow 266 can include the same or different operations of the extensive health check 236 and the extensive health check 440. Then a report can be generated at 272 and results can be returned or otherwise presented to the user or the support personnel at 274. The report can include, for example, user information, simulation job information such as elapsed time, hardware resources information, simulator version and build, errors and warnings, or other information. In some implementations, after performing the extensive health check 266, the health of the computing nodes can be checked again at 268. The computing node health check 268 can be performed as part of a screening process to either eliminate the hardware failure or confirm it. If the hardware is healthy, the process proceeds from 268 to 216. Otherwise, the process will take it from 268 to 266 for thorough investigation. If the computing nodes are identified as healthy, the workflow D 220d proceeds from 268 to 216 where the resources can be released, and workflow A 200a is triggered again. If the computing nodes are identified as bad computing nodes at 268, the workflow D 220d proceeds from 268 to 224 where the bad computing nodes are isolated, and workflow C 200c is triggered.

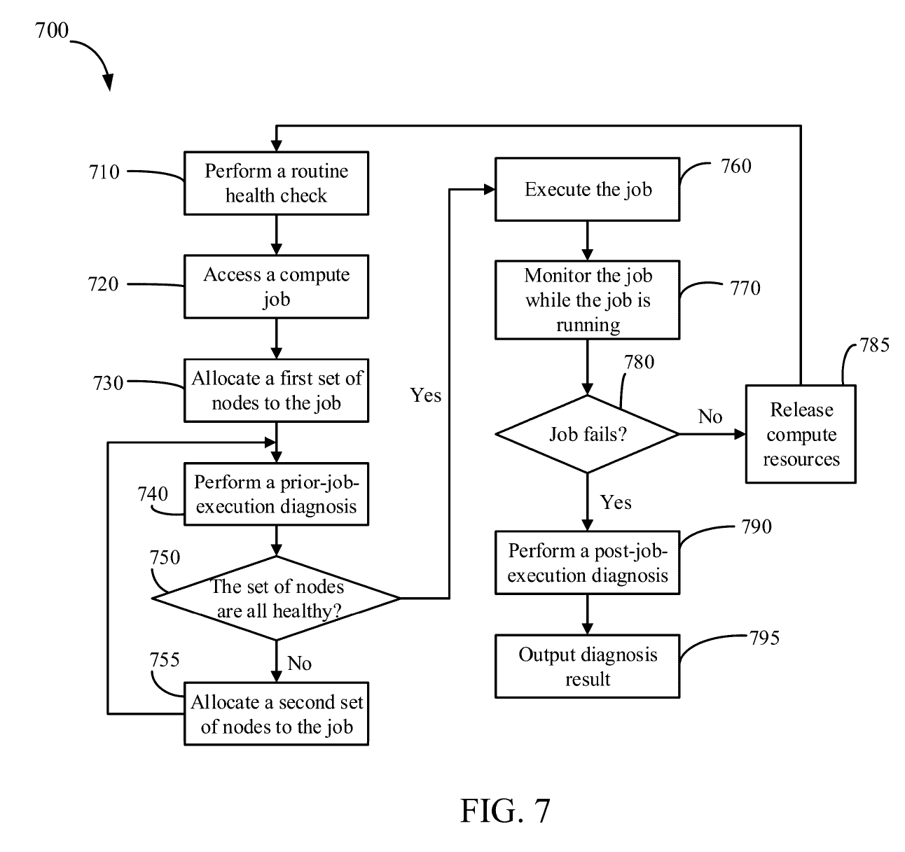

FIG. 7 is a flowchart illustrating an example process 700 for performing a computing node health check, according to an implementation. The process 700 can be implemented, for example, as computer instructions stored on computer-readable media and executable by data-processing apparatus (for example, one or more computing nodes of the computer system 100 in FIG. 1). In some implementations, some or all of the operations of process 700 can be distributed to be executed by a cluster of computing nodes, in sequence or in parallel, to improve efficiency. The example process 700, individual operations of the process 700, or groups of operations may be iterated or performed simultaneously (for example, using multiple threads). In some cases, the example process 700 may include the same, additional, fewer, or different operations performed in the same or a different order.

At 710, a routine health check is performed, for example, by operation of a computer system that has a number of computing nodes (for example, the computer system 100 in FIG. 1). The routine health check can include some or all of the operations of the workflow A 200a, or the routine health check can be performed in another manner. From 710, the example process 700 proceeds to 720.

At 720, a computing job can be received or otherwise accessed, for example, by operation of a computer system. The computing job can be a simulation job, a calculation job, or another computing job that may require a large amount of computer operations (additions, multiplications, etc.). The computing job can be, for example, submitted by a user via a user interface, or a pending job in a queue of a scheduler waiting for its turn to be executed. The computing job can require some computing resources, for example, a particular number of computing nodes. The computing nodes can have associated processing power and memory. From 720, the example process 700 proceeds to 730.

At 730, a first set of computing nodes is allocated, for example, by a scheduler of the computer system (for example, the scheduler 136 of the computer system 100) to the computing job from the number of computing nodes of the computer system. From 730, the example process 700 proceeds to 740.

At 740, a prior-job-execution diagnosis is performed on the first set of computing nodes. The prior-job-execution diagnosis can include some or all of the operations of the workflow B 200b and workflow C 200c, or the prior-job-execution diagnosis can be performed in another manner. For example, performing the prior-job-execution diagnosis can include one or more of performing a syntax check, resources optimization, resource allocation, or an extensive health check, according to the example techniques described with respect to FIGS. 2A-4. From 740, the example process 700 proceeds to 750.

At 750, whether the first set of computing nodes are all healthy is determined. In some implementations, the determination can be made in a similar manner to the determination 208 in FIG. 2A. If all the first set of computing nodes are healthy, the example process 700 proceeds from 750 to 760. If the first set of computing nodes are not all healthy, the example process 700 proceeds from 750 to 755.

At 755, a second set of computing nodes is allocated to the job prior to executing the job. From 755, the example process 700 can go back to 740 to perform a prior-job-execution diagnosis on the second set of computing nodes to make sure the second set of computing nodes are all healthy before executing the job.

In some implementations, the computer system can maintain a healthy computing node pool (for example, the healthy computing node pool 210) and a bad computing node pool (for example, the bad computing node pool 230). In response to determining that the first set of computing nodes are not all healthy, one or more bad computing nodes can be identified from the first set of computing nodes, for example, according to the example techniques described with respect to 218. The identified bad computing nodes can be put into the bad computing node pool of the computer system. The one or more bad computing nodes can be isolated from healthy computing nodes of the first set of computing nodes, fixed, and tested, for example, according to the example operations described with respect to workflow C 200c. In some implementations, in response to determining that the one or more fixed bad computing nodes pass an extensive health check (for example, the extensive health check 236), the one or more fixed bad computing nodes can be put into the healthy computing node pool of the computer system. In some implementations, the second set of computing nodes can be selected from the healthy computing node pool that contains checked healthy computing nodes. As such, the example process 700 proceeds from 755 to 760 without performing the prior-job-execution diagnosis on the second set of computing nodes.

In some implementations, in response to determining that the first set of computing nodes are not all healthy, the job can be sent back to a scheduler with the same job identifier (ID); and the job can be labeled with a higher or the same priority to be scheduled for execution later.

At 760, in response to determining that the first set of computing nodes are healthy, the job has started executing. From 760, the example process 700 proceeds to 770.

At 770, the job is monitored while the job is running. The job can be monitored according to the job monitoring workflow 212, the example job monitoring process 500, or in another manner. For example, monitoring the job while the job is running can include performing a health check with a frequency not to impact the running job; and checking, in parallel with performing the health check, progress of the job to determine that the job is alive and still running From 770, the example process 700 proceeds to 780.

At 780, whether the job fails or succeeds is determined, for example, according to the example techniques described with respect to 214. If the job is successfully executed, the example process 700 proceeds to 785 where the computing resources (for example, the second set of computing nodes allocated to the job) can be released, for example, by putting them back into the resource pool of the computer system. From 785, the example process 700 can go back to 710 to perform a routine health check. On the other hand, if the job fails, the example process 700 proceeds to 790.

At 790, in response to determining that the job fails, a post-job-execution diagnosis is performed on an exit code of the job. The post-job-execution diagnosis can include some or all operations of the example workflow D 200d, or the post-job-execution diagnosis can be performed in another manner. For example, performing the post-job-execution diagnosis can include categorizing an error of the job; fixing the error of the job according to a category of the error; and resubmitting the job. In some implementations, categorizing the error of the job can include categorizing the error into one or more of a syntax error, an application error, an environment error, a hardware error or another error. In some implementations, fixing the error of the job according to a category of the error can include fixing the error of the job according to the example techniques described with respect to work flows 254, 256, 258, or 260 or the example process 600). From 790, the example process 700 proceeds to 795.

At 795, a result of the post-job-execution diagnosis is output via a user interface. The result of the post-job-execution diagnosis can include a detailed report as described with respect to 272 and 274. The post-job-execution diagnosis result can be presented to the user, the support personnel, or others for further analysis, archives, or other uses. After 795, the example process 700 stops or goes back to 710 for a routine health check of the computing nodes of the computer system.

The operations described in this disclosure can be implemented as operations performed by a data-processing apparatus on data stored on one or more computer-readable storage devices or received from other sources. The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be deployed to be executed on one computer or on multiple computers that are located at one site or distributed across multiple sites and interconnected by a communication network.

While this disclosure contains many specific implementation details, these should not be construed as limitations on the scope of any implementations or of what may be claimed, but rather as descriptions of features specific to particular implementations. Certain features that are described in this disclosure in the context of separate implementations can also be implemented in combination or in a single implementation. Conversely, various features that are described in the context of a single implementation can also be implemented in multiple implementations separately or in any suitable sub-combination. Moreover, although features may be described previously as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed to achieve desirable results. In certain circumstances, multitasking and parallel processing may be advantageous. Moreover, the separation of various system components in the implementations described previously should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for computing node health check, the method comprising:
performing, by operation of a computer system, a routine health check of a plurality of computing nodes of a computer system;
accessing, by operation of the computer system, a computing job;
allocating a first set of computing nodes from the plurality of computing nodes to the computing job;
performing a prior-job-execution diagnosis on the first set of computing nodes;
determining whether the first set of computing nodes are all healthy;
in response to determining that the first set of computing nodes are healthy, executing the job;
monitoring the job while the job is running;
determining whether the job fails or succeeds;
in response to determining that the job fails, performing a post-job-execution diagnosis on an exit code of the job; and
outputting, via a user interface, a result of the post-job-execution diagnosis.

2. The method of claim 1, further comprising:
determining whether the first set of computing nodes are not all healthy;
in response to determining that the first set of computing nodes are not all healthy, identifying one or more bad computing nodes from the first set of computing nodes; and
prior to executing the job, allocating a second set of computing nodes from a healthy computing node pool to the job.

3. The method of claim 2, further comprising:
isolating the one or more bad computing nodes from healthy computing nodes of the first set of computing nodes;
fixing the one or more bad computing nodes;
testing the one or more fixed bad computing nodes; and
in response to determining that the one or more fixed bad computing nodes pass an extensive health check, putting the one or more fixed bad computing nodes to the healthy computing node pool.

4. The method of claim 2, further comprising:
in response to determining that the first set of computing nodes are not all healthy,
sending the job back to a scheduler; and
marking the job with a higher priority to be scheduled for execution.

5. The method of claim 1, where performing the prior-job-execution diagnosis comprises one or more of performing syntax check, resources optimization, resource allocation, or an extensive health check.

6. The method of claim 1, where performing the post-job-execution diagnosis comprises:
categorizing an error of the job;
fixing the error of the job according to a category of the error; and
resubmitting the job.

7. The method of claim 6, where categorizing the error of the job comprises categorizing the error into one or more of a syntax error, an application error, an environment error, a hardware error or another error.

8. The method of claim 1, where monitoring the job while the job is running comprises:
performing a health check with a frequency not to impact the running job; and
checking, in parallel with performing the health check, progress of the job to determine that the job is alive and still running.

9. A non-transitory computer-readable medium storing instructions executable by a computer system to perform operations comprising:
performing a routine health check of a plurality of computing nodes of a computer system;
accessing a computing job;
allocating a first set of computing nodes from the plurality of computing nodes to the computing job;
performing a prior-job-execution diagnosis on the first set of computing nodes;
determining whether the first set of computing nodes are all healthy;
in response to determining that the first set of computing nodes are healthy, execute the job;
monitoring the job while the job is running;
determining whether the job fails or succeeds;
in response to determining that the job fails, performing a post-job-execution diagnosis on an exit code of the job; and
outputting, via a user interface, a result of the post-job-execution diagnosis.

10. The computer-readable medium of claim 9, further comprising:
determining whether the first set of computing nodes are not all healthy;
in response to determining that the first set of computing nodes are not all healthy, identifying one or more bad computing nodes from the first set of computing nodes; and
prior to executing the job, allocating a second set of computing nodes from a healthy computing node pool to the job.

11. The computer-readable medium of claim 10, further comprising:
isolating the one or more bad computing nodes from healthy nodes of the first set of computing nodes;
fixing the one or more bad computing nodes;
testing the one or more fixed bad computing nodes; and
in response to determining that the one or more fixed bad computing nodes pass an extensive health check, putting the one or more fixed bad computing nodes to the healthy node pool.

12. The computer-readable medium of claim 10, further comprising:
in response to determining that the first set of computing nodes are not all healthy,
sending the job back to a scheduler; and
marking the job with a higher priority to be scheduled for execution.

13. The computer-readable medium of claim 9, where performing the prior-job-execution diagnosis comprises one or more of performing syntax check, resources optimization, resource allocation, or an extensive health check.

14. The computer-readable medium of claim 9, where performing the post-job-execution diagnosis comprises:
categorizing an error of the job;
fixing the error of the job according to a category of the error; and
resubmitting the job.

15. The computer-readable medium of claim 14, where categorizing the error of the job comprises categorizing the error into one or more of a syntax error, an application error, an environment error, a hardware error or another error.

16. The computer-readable medium of claim 9, where monitoring the job while the job is running comprises:
performing a health check with a frequency not to impact the running job; and
checking, in parallel with performing the health check, progress of the job to determine that the job is alive and still running.

17. A system comprising one or more computers that include:
memory operable to store computing node health check programs; and
data-processing apparatus operable to:
perform a routine health check of a plurality of computing nodecomputing computing nodes of a computer system;
access a computing job;
allocate a first set of computing nodes from the plurality of computing nodes to the computing job;
perform a prior-job-execution diagnosis on the first set of computing nodes;
determine whether the first set of computing nodes are all healthy;
in response to determining that the first set of computing nodes are healthy, execute the job;
monitor the job while the job is running;
determine whether the job fails or succeeds;
in response to determining that the job fails, perform a post-job-execution diagnosis on an exit code of the job; and
output, via a user interface, a result of the post-job-execution diagnosis.

18. The system of claim 17, the data-processing apparatus further operable to:
determine whether the first set of computing nodes are not all healthy;
in response to determining that the first set of computing nodes are not all healthy, identifying one or more bad computing nodes from the first set of computing nodes; and
prior to executing the job, allocate a second set of computing nodes from a health computing node pool to the job.

19. The system of claim 18, the data-processing apparatus further operable to:
isolate the one or more bad computing nodes from healthy computing nodes of the first set of computing nodes;
fix the one or more bad computing nodes;
test the one or more fixed bad computing nodes; and
in response to determining that the one or more fixed bad computing nodes pass an extensive health check, put the one or more fixed bad computing nodes to the healthy computing node pool.

20. The system of claim 18, the data-processing apparatus further operable to:
in response to determining that the first set of computing nodes are not all healthy,
send the job back to a scheduler; and
mark the job with a higher priority to be scheduled for execution.
